(19) United States
(12) Patent Application Publication
(10) Pub. No.: US 2020/0126013 A1
(43) Pub. Date: Apr. 23, 2020

(54) MICROCOMPONENTS FOR DATA INTEGRATION AND METHODS THEREOF

(71) Applicant: ENOSIX, INC., Cincinnati, OH (US)

(72) Inventors: Steven C. Hochheiser, Huntington Beach, CA (US); Timothy W. Lewis, Toledo, OH (US); Gerald Schlechter, Cincinnati, OH (US); Matthew James Hail, Springboro, OH (US)

(21) Appl. No.: 16/660,418

(22) Filed: Oct. 22, 2019

Related U.S. Application Data
(60) Provisional application No. 62/749,356, filed on Oct. 23, 2018.

(51) Int. Cl. G06Q 10/06; G06F 16/23; G06Q 30/00

(52) U.S. Cl. CPC G06Q 10/06313; G06Q 30/01; G06F 16/2365

(57) ABSTRACT

Microcomponents are provided for real-time process integration between a customer relationship management system or a sales configuration system and an enterprise resource planning system. The microcomponents allowing for rapid integration of data presented from both systems to allow for interactive display and manipulation of data across systems without the need for data synchronization or complex API integration via third party tools.

### CROSS REFERENCE TO RELATED APPLICATION

This application claims the benefit of U.S. provisional patent application Ser. No. 62/749,356, filed on Oct. 23, 2018, the disclosure of which are incorporated herein by reference in its entirety.

### BACKGROUND

Enterprises often store and access business information in a number of different ways. For example, an enterprise might store a substantial amount of information about production, sales, human resources, etc. in multiple database structures created by one or more business service providers. In this regard, an enterprise may store certain information in a cloud-based customer relationship management (CRM) system, such as offered by SALESFORCE of San Francisco, Calif., or other sales configuration software systems. The enterprise may store other information in an enterprise resource planning (ERP) system, such as offered by SAP SE of Waldorf, Germany. A user of one of the systems may have to wait hours or even days in order to retrieve information from the other system, which can negatively impact productivity, slow workflows, and have other detrimental effects. There exists a need to integrate an enterprise's CRM system or sales configuration software system with an ERP system to allow faster and more efficient access to information without complex additional middleware or additional infrastructure, thereby improving workflows and productivity.

### BRIEF DESCRIPTION OF THE DRAWINGS

It is believed that certain embodiments will be better understood from the following description taken in conjunction with the accompanying drawings, in which like references indicate similar elements and in which:

FIG. 1 depicts real-time microcomponents in accordance with one non-limiting embodiment.

FIG. 2 is a message sequence chart schematically depicting example real-time communications between a CRM system and an ERP system facilitated by the integration links in accordance with one non-limiting embodiment.

FIGS. 3-8 are example processes in accordance with the present disclosure.

FIGS. 9A-9C depicts smart business objects (SBOs) enabling real-time, bi-directional data flow between a CRM system and an ERP system.

### DETAILED DESCRIPTION

Various non-limiting embodiments of the present disclosure will now be described to provide an overall understanding of the principles of the structure, function, and use of systems and methods disclosed herein. One or more examples of these non-limiting embodiments are illustrated in the selected examples disclosed and described in detail with reference made to the figures in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

The systems, apparatuses, devices, and methods disclosed herein are described in detail by way of examples and with reference to the figures. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. In addition, elements illustrated in the figures are not necessarily drawn to scale for simplicity and clarity of illustration. For ease of reading and clarity, certain components, modules, or methods may be described solely in connection with a specific figure. In this disclosure, any identification of specific techniques, arrangements, etc. are either related to a specific example presented or are merely a general description of such a technique, arrangement, etc. Identifications of specific details or examples are not intended to be, and should not be, construed as mandatory or limiting unless specifically designated as such. Any failure to specifically describe a combination or sub-combination of components should not be understood as an indication that any combination or sub-combination is not possible. It will be appreciated that modifications to disclosed and described examples, arrangements, configurations, components, elements, apparatuses, devices, systems, methods, etc. can be made and may be desired for a specific application. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Throughout this disclosure, references to components or modules generally refer to items that logically can be grouped together to perform a function or group of related functions. Like reference numerals are generally intended to refer to the same or similar components. Components and modules can be implemented in software, hardware, or a combination of software and hardware.

The term “software” is used expansively to include not only executable code, for example machine-executable or machine-interpretable instructions, but also data structures, data stores and computing instructions stored in any suitable electronic format, including firmware, and embedded software. The terms “information” and “data” are used expansively and includes a wide variety of electronic information, including executable code; content such as text, video data, and audio data, among others; and various codes or flags. The terms “information,” “data,” and “content” are sometimes used interchangeably when permitted by context.

It should be noted that although for clarity and to aid in understanding some examples discussed herein might describe specific features or functions as part of a specific component or module, or as occurring at a specific layer of a computing device (for example, a hardware layer, operating system layer, or application layer), those features or functions may be implemented as part of a different component or module or operated at a different layer of a communication protocol stack. Those of ordinary skill in the art will recognize that the systems, apparatuses, devices, and methods described herein can be applied to, or easily modified for use with, other types of equipment, can use other arrangements of computing systems such as client-server distributed systems, and can use other protocols, or operate at other layers in communication protocol stacks, than are described.

The systems, apparatuses, devices, and methods disclosed herein generally relate to real-time process integration between a various systems, such as a customer relationship management (CRM) system and an enterprise resource planning (ERP) system, thereby allowing for rapid integration of data presented from both systems and bi-directional data movement along a business process flow. Additionally or alternatively, the systems, apparatuses, devices, and methods disclosed herein can be used to integrate a variety of other types of software systems, such as sales configuration systems (sometimes referred as Configure, Price, Quote (CPQ) systems) and ERP systems. For the purposes of illustration, many example embodiments are described herein in the context of integrating a CRM system with an ERP system. It is to be readily appreciated, however, that such integration techniques are applicable to various CPQ systems and ERP systems. Example CPQ system include SAP CPQ offered by SAP SE of Waldorf, Germany and ORACLE CPQ Cloud offered by Oracle Corp. of Redwood Shores, Calif.

The systems, apparatuses, devices, and methods disclosed herein can beneficially allow for interactive display and manipulation of data across systems without the need for data synchronization or complex application programming interface (API) integration via third party tools. The service-oriented framework described herein can be based on loosely-coupled integration points to support synchronous, low-latency data consumption and provide quick adaptability to new business requirements. Further, the reusable integration links described herein, sometimes referred to as smart business objects (SBOs) can be focused on specific tasks or processes and utilize low code configuration.

Synchronous real-time CRM and ERP integration in accordance with the present disclosure can enable companies to gain greater insights and intelligence while overcoming the deficiencies of the conventional approaches for data retrieval and management. Accordingly, providing real-time integration of customer order history, pricing, discounts and previously purchased bundles stored in ERP systems into a CRM using the SBOs described herein can drive better decisions on which customers are most likely to buy upsells, cross-sells and new products, among other types of decisioning. Thus, instead of having to rely just on information regarding a given customer provided by a CRM system, utilizing the systems and methods described herein, sales teams can, for instance, analyze sales history to find potential purchasing trends and indications of who can sign off on deals in progress.

Further, such real-time integration is enabled by the systems and methods described herein without the need for extensive field mapping between the different systems, which is a lengthy and error-prone process. The integration technology provided herein therefore addresses the challenges of integrating cloud and on-premise systems and can beneficially streamline and improve revenue-generating business processes through the bridging of legacy ERP and CRM systems.

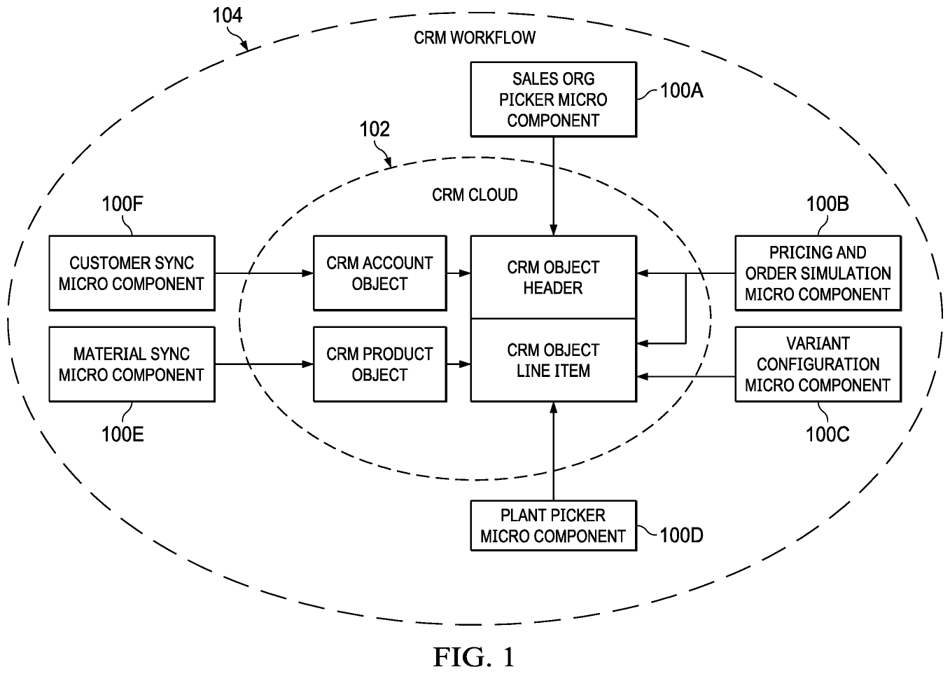

In accordance with various embodiments, the present disclosure utilizes real-time microcomponents that are schematically shown in FIG. 1. Such microcomponents 100A-F can focus on very specific tasks of creating, processing, and retrieving particular data and transactions from a customer relationship management system 102. The real-time microcomponents in accordance with the present disclosure, can operate independently or together utilizing workflows 104 associated with the associated CRM system 102 thereby allowing flexibility. Without limitations, example real-time microcomponents 100 A-F can be bounded to any CRM transactions or processes, such as related to opportunity, quotation, sales order, invoice, case, and so forth. Moreover, in some embodiments the CPQ functionality is provided by the CRM system 102. In other embodiments, the CPQ functionality is provided through a specialized software platform, such as a CPQ system. Beneficially, in accordance with some embodiments, such real-time microcomponents can be configurable by an administrator of the CRM system, thereby minimizing complex coding. Moreover, since real-time microcomponents 100A-F can be independent of each other, functional and technical upgrades can be minimally evasive, as one component can be upgraded or patched without necessarily affecting the others.

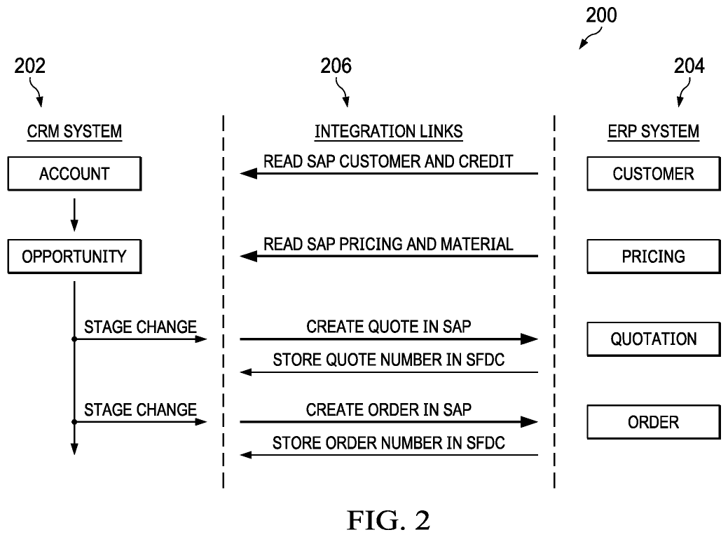

FIG. 2 is a message sequence chart 200 schematically depicting example real-time communications between a CRM system 202 and an ERP system 204 facilitated by the integration links 206 of the present disclosure. While a CRM system 202 is illustrated, in some embodiments the integration links 206 can facilitate integration between the ERP system 204 and other types of systems, such as a CPQ system. In any event, in accordance with the systems and methods described herein, the real-time microcomponents provide integration links 206 so that data can be read from the ERP system 204 into the CRM system 202 in real-time. Additionally, data from the CRM system 202 can be read into the ERP system 204, as shown in FIG. 2. Accordingly, bi-directional data movement is enabled during a business process flow initiated by a user of the CRM system 202. As is to be appreciated, the techniques described herein can be used with a variety of front-end CRM systems, such as CRM systems offered by Microsoft and Oracle. Further, the techniques described herein can used with a variety of different workflows associated with that CRM system to provide real-time data exchange between the CRM and an ERP system. In some embodiments, the techniques are enabled through a plug-in, application, or other type of add-on that is installed or otherwise executed within a CRM environment. Once installed, the framework can generate the smart business objects which can be used to provide the real-time communication bridge between the CRM system 202 and the ERP system 204.

For the purposes of illustration, one example embodiment is described below in the context of a “Configure, Price, Quote” (CPQ) business workflow, as may be implemented through a CRM system, such as Salesforce, or implemented through other types of software platforms, such as cloud-based CPQ software offerings. As is to be appreciated, however, the approach described below can be readily usable for other workflows available through a CRM system. For instance, while the microcomponents described below are focused on performing tasks associated with the CPQ workflow, other CRM workflows can utilize other microcomponents, as may be required. Further, while the example embodiment is described using Salesforce and SAP terminology for illustration purposes, it is to be appreciated that other CRM and ERP systems may utilize different terminology. Applying the systems and methods described herein to those CRM and ERP systems is within the scope of the present disclosure.

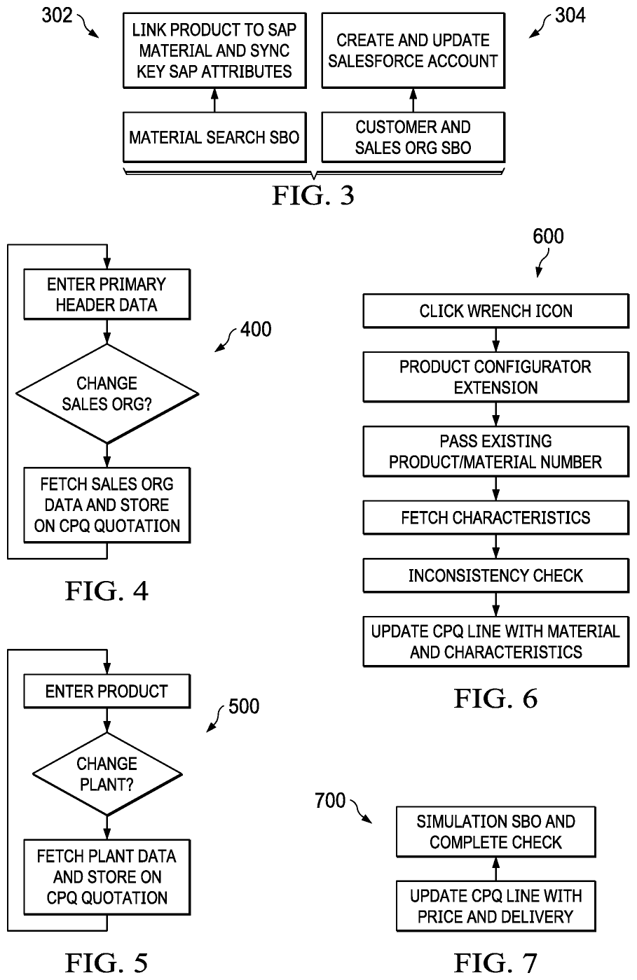

Referring to FIG. 3, a batch routine 302 can be executed periodically, such as daily, to sync data, shown as “SAP Material”, to create or update a Salesforce Product Object with primary product data as defined in a mapping for the client system. Similarly, a batch routine 304 can be executed periodically, such as daily, to sync data, shown as “SAP Customer/Sales Org”, to create or update Salesforce Account Object with primary account data as defined in a mapping provided by the client system.

When creating a CPQ quote, the Salesforce Primary Account Data can be used as the default. A user can optionally change the CPQ Header Data as defined in the CPQ template using a real-time function “Sales Org Picker” call to fetch sales organization data from the SAP system to update the CPQ Quotation Header, as shown by the process 400 in FIG. 4. This approach utilizes a real-time API call to the ERP system to provide real-time data, as opposed to relying on potentially out of date data that is provided by a data sync.

Similarly, when creating a CPQ quote line, Salesforce Primary Product Data can be used as the default. A user can change the CPQ Line Item Data as defined in CPQ template using real-time function “SAP Plant Picker” call to fetch available plants from the SAP system to update the CPQ Quotation Line Item, as shown by the process 500 in FIG. 5. Thus, real-time plant availability can be brought from the ERP system into the CRM system.

Referring now to FIG. 6, after selecting a Salesforce product that is flagged as being configurable, a configuration icon can be graphically display on the CPQ item. Activating the configuration icon can allow a user to initiate an SAP variant configuration process. The variant configuration process can be used, for instance, when quoting complex products with complication specifications. Data as documented on a template worksheet can be passed to the SAP variant configuration through an API. A user can configure the system to view pricing during configuration or when the pricing is stored on the CPQ Quotation Line. After the configuration process, information such as Model, Material Characteristics, and Plant can be stored on CPQ Quote Line. Accordingly, using the process 600 shown in FIG. 6, as a product is being configured for a quote, various rule-based options can be retrieved from the ERP system in real-time and presented to the user through the CRM software interface.

Upon an update of the CPQ line item from the variant configuration, sales organization data from the CPQ header and material Data stored on the CPQ line item can be passed via a quotation simulation in accordance with the present disclosure and as defined in the template worksheet. Various data, such as pricing data and availability data, can be returned and the CPQ quotation line item can be updated, as shown by process 700 in FIG. 7. It is noted that non-configuration items can also be simulated.

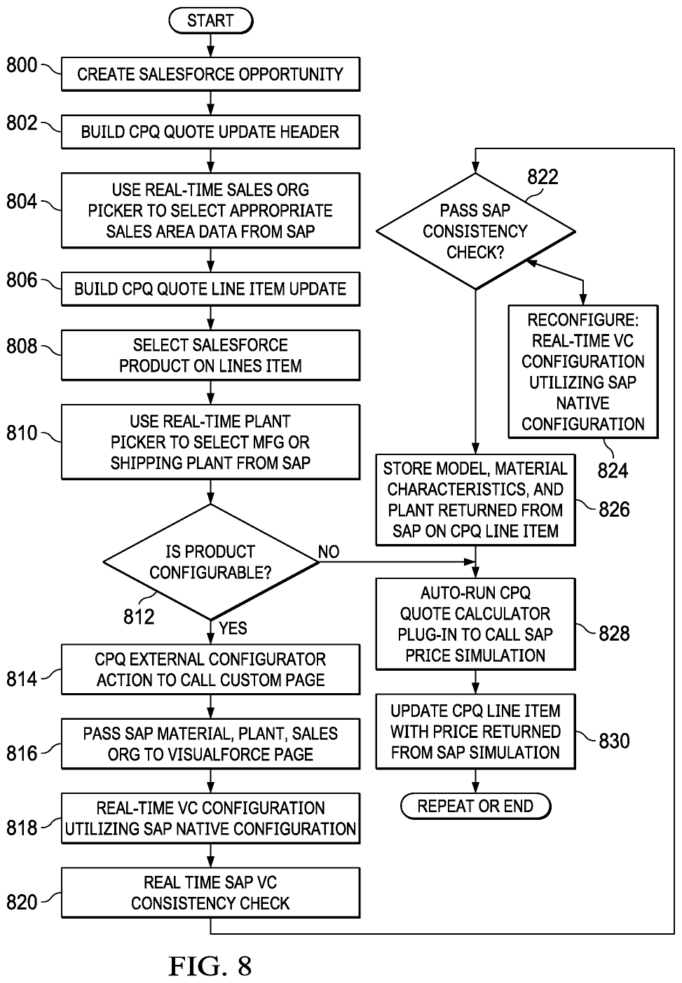

Referring now to FIG. 8, an example CPQ process in accordance with the present disclosure is shown. As shown, the process depicts the use of data from an ERP system, shown as SAP, to create a quote using a CRM system, shown as Salesforce. As described above, however, the present disclosure is not limited to CPQ processes that are provided by a CRM system. Instead, the present disclosure is applicable to a variety of different CPQ processes, including processes that are provided by specialized CPQ platforms, CPQ systems, and the like.

In the illustrated embodiment, the user first creates an opportunity in the CRM system and initiates the CPQ process at 800, 802. At 804, Using a real-time sales organization picker microcomponent, the user selects the appropriate sales area data from SAP, similar to FIG. 4, above. At 806, the user builds the CPQ quote line items. Based on the product selected at 808, a real-time plant picker microcomponent is used to select the manufacturing or shipping plant from SAP, similar to FIG. 5, above. At 812, it is determined if the product is configurable. If the product is not configurable, the process advances to price simulation at 828. If the product is configurable, the user is able to modify the product through the variant configuration process at 814-818, similar to FIG. 6, above. A consistency check is performed at 820-824 to ensure the configuration options are valid. At 826-830, price simulation is performed to provide quote information, similar to FIG. 7, above.

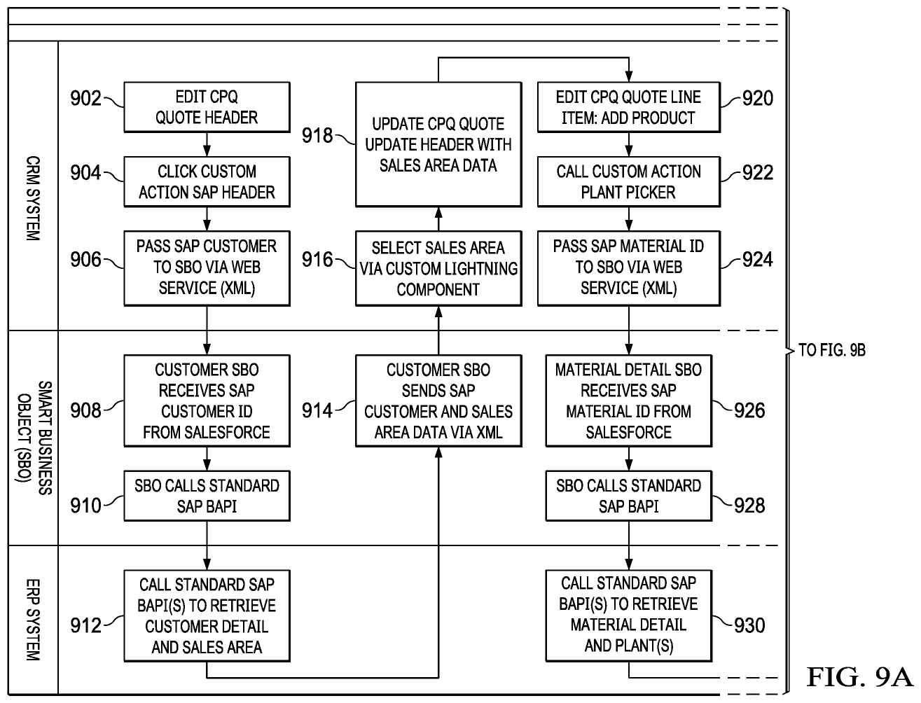

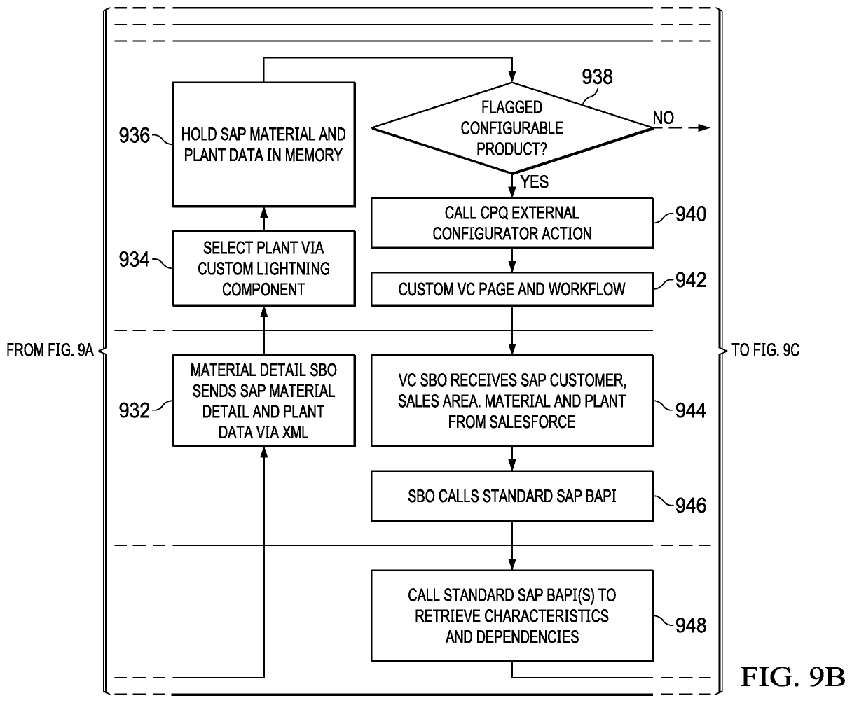

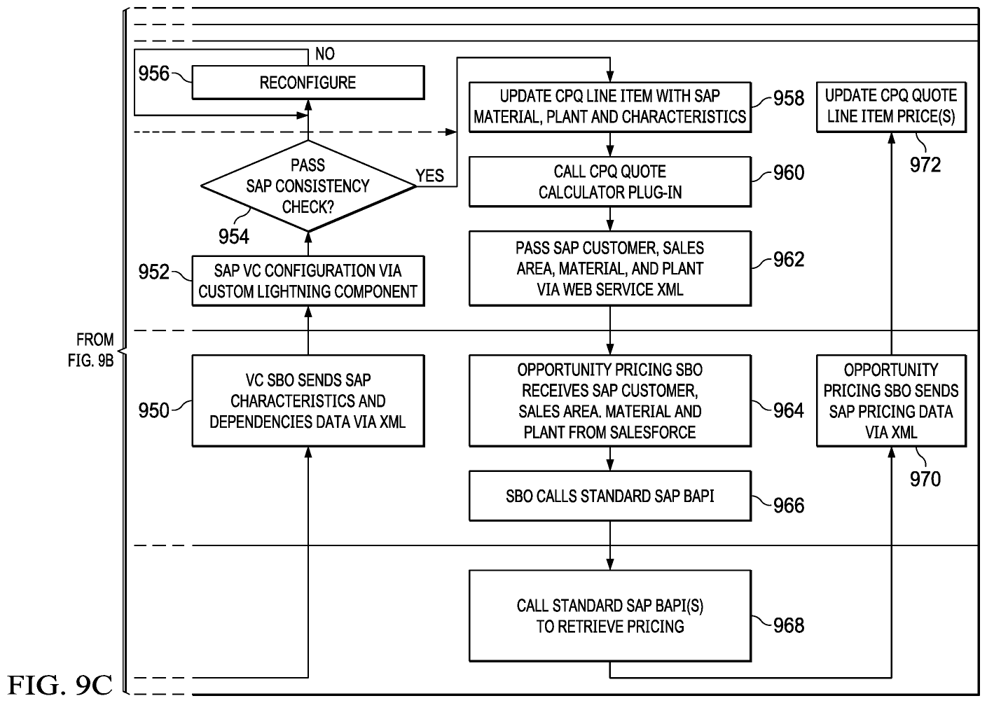

Referring now to FIGS. 9A-C, smart business objects (SBOs) are shown enabling real-time, bi-directional data flow between a CRM system and an ERP system. Again, while the process in FIGS. 9A-C is depicted in the context of a CPQ process utilizing Salesforce and SAP for illustration purposes, this disclosure is not so limited, as such SBOs can enable real-time, bi-directional data flow between a variety of different systems. In the illustrated embodiment, a CPQ process is first initiated in Salesforce. As part of the initiated process, the user can pick a Salesforce account that has an SAP customer ID associated with it. A daily Salesforce batch job can execute an SAP customer sync to link an SAP customer ID to the Salesforce account, as described above with regard to FIG. 3. At 902, the user edits the header of the CPQ Quote. At 904, the user can initiate a custom action to update the SAP Header. As depicted at 906-918, a sales area picker can be called. The sale area picker uses the SAP customer number that is attached to the CPQ quote to determine the SAP customer ID associated with the account. Once the SAP customer ID is determined, a list of Sales Areas Data (Sales Org, Distribution Channel, Division) available for that customer in SAP can be pulled from SAP using API-based communication. It is noted that the CPQ custom action described herein is at the quote level as opposed to the line item level. Furthermore, as shown in 906, Salesforce can make a web service call to the SBO using an XML format structure The SBO can then convert the XML data into an API call in order to request and receive the appropriate data from SAP and return it to Salesforce.

At 910-912, a customer smart bFusiness object passes the SAP customer ID to the Standard SAP BAPI to look up the customer using SAP customer ID. Customer details are returned, which can include sales area information associated with that customer. It is noted that SAP requires sales area data to process any price simulation or create any document, however, other CRM system may not have such a requirement. At 916, the user then selects an SAP Sales Area via the Salesforce interface. Then, as part of the sales area picker process, the sales area selection is saved to the CPQ quote header at 918. In accordance with various embodiments, future quotes can automatically display the previously selected sales area while giving the user the ability to change it, as may be necessary. It is noted that the CPQ quote configuration options are based on the sales area selected. Salesforce can also call a customized page, such as a visual force page, that contains an application that includes a particular process flow. Then, once the flow completes, there can be a visual force page action that is invoked which persists the information to the Salesforce CPQ quote header SObject record.

At 920, a user enters products to be quoted. If a configurable product is selected, a custom action can check to ensure an SAP sales area has previously been selected. If there was no sales area previously selected, the user can use the custom action “Sales Org Picker” to select one. If there was an SAP Sales Area previously selected it can be displayed while offering the user the ability to change if desired. After product selection has occurred, a customized plant picker process can be performed, as shown at 922-936, to display to user a list of SAP plants based on the SAP sales area. The plant picker process can use the SAP material number stored on the Salesforce product SObject to execute a web service call to the smart business object Material Detail Table in SAP. At 924, Salesforce cam make a web service call using XML format structure according to a smart business object “Material Detail” add-on. Data can be in an XML format that is structured in way to be efficiently handled by SAP. At 926-932, the Material Details smart business object passes the SAP Material ID to the standard SAP BAPI and returns material detail which includes plant(s). It is noted that SAP requires “Material ID” and “Plant” to process any price simulation or create any document. Furthermore, a daily Salesforce batch job can execute an SAP material sync to link SAP Material ID to Salesforce Product(s), as described above with regard to FIG. 3. At 936, the SAP plant can be stored in memory until the configuration is finalized.

At 938-956, a product configuration can be executed in accordance with the present disclosure. A customized visual force page can house a customized embedded flow for SAP Variant Configuration (VC). SAP VC characteristics and option dependencies can be displayed based on the SAP material and plant selected per the SAP configuration. A user can configure the item in Salesforce utilizing a lighting component in accordance with the present disclosure which calls a VC smart business object. Salesforce can make a web service call using an XML format structure according to the smart business object SAP add-on. Data can be in an XML Format structured in way to be efficiently handled by SAP.

A characteristics picker action can be utilized to determine which characteristics are available. If there are any characteristics in SAP listed as hidden, they are not displayed in Salesforce. Available values for each characteristic, depending on user selection, can be dynamically displayed in real time. Additionally, based on user selection in real time, the required characteristics can be dynamically determined. Depending on the kind of values that exist for each characteristic, the display can vary. For instance, for a single value option, a drop down of values associated with that characteristic can be displayed where a user can only select one. Whereas for a multi value option, a drop down of values can be displayed with boxes that can be checked so that a user can select multiple options for that characteristic. For other types of characteristics, other input mechanisms can be used, such as a text box, to permit a user to enter notes.

The VC SBO can run an SAP VC consistency check in real-time as user makes selections based on SAP definitions of what is valid. If a combination of configuration options selected is determined to be invalid, the user is unable to finalize and save their configuration. Therefore, only if the combination of configuration options selected is deemed to be valid is a user able to finalize and save their configuration. A user also can also selectively reset the configuration back to default values prior to any user selections. Once a user finalizes their configuration the configuration can be saved and persisted back to the Salesforce CPQ line item. SAP Model/Material Number, Plant, and Sales Area can be stored at the item level of the Salesforce CPQ quote. The user can have the option to revisit the custom configuration page and all previously options selected will be displayed. Additionally, if the user makes changes then validation checks can be reinitiated to ensure configuration is valid before user can re-finalize with new values.

At 958-972, a price simulation process can be performed. A customized Salesforce CPQ quote calculator plugin in accordance with the present disclosure, referred to as an opportunity pricing smart business object in FIGS. 9A-C, can be utilized to calculate pricing per the SAP Configuration. SAP Customer ID, Sales Area Data (Sales Organization, Distribution Channel, Division), Material ID, and Plant can be submitted to the opportunity pricing SBO which, in turn, calls the standard SAP BAPI to simulate the creations of an SAP document. The pricing data can then be returned from SAP via the framework described herein and stored on the Salesforce CPQ Quote Line Item.

It is to be understood that the figures and descriptions of the present invention have been simplified to illustrate elements that are relevant for a clear understanding of the present invention, while eliminating, for purposes of clarity, other elements. Those of ordinary skill in the art will recognize, however, that these sorts of focused discussions would not facilitate a better understanding of the present invention, and therefore, a more detailed description of such elements is not provided herein.

Any element expressed herein as a means for performing a specified function is intended to encompass any way of performing that function including, for example, a combination of elements that performs that function. Furthermore the invention, as may be defined by such means-plus-function claims, resides in the fact that the functionalities provided by the various recited means are combined and brought together in a manner as defined by the appended claims. Therefore, any means that can provide such functionalities may be considered equivalents to the means shown herein. Moreover, the processes associated with the present embodiments may be executed by programmable equipment, such as computers. Software or other sets of instructions that may be employed to cause programmable equipment to execute the processes may be stored in any storage device, such as, for example, a computer system (non-volatile) memory, an optical disk, magnetic tape, or magnetic disk. Furthermore, some of the processes may be programmed when the computer system is manufactured or via a computer-readable memory medium.

It can also be appreciated that certain process aspects described herein may be performed using instructions stored on a computer-readable memory medium or media that direct a computer or computer system to perform process steps. A computer-readable medium may include, for example, memory devices such as diskettes, compact discs of both read-only and read/write varieties, optical disk drives, and hard disk drives. A non-transitory computer-readable medium may also include memory storage that may be physical, virtual, permanent, temporary, semi-permanent and/or semi-temporary.

These and other embodiments of the systems and methods can be used as would be recognized by those skilled in the art. The above descriptions of various systems and methods are intended to illustrate specific examples and describe certain ways of making and using the systems disclosed and described here. These descriptions are neither intended to be nor should be taken as an exhaustive list of the possible ways in which these systems can be made and used. A number of modifications, including substitutions of systems between or among examples and variations among combinations can be made. Those modifications and variations should be apparent to those of ordinary skill in this area after having read this disclosure.

What is claimed is:

1. A computer-based method of integrating a customer relationship management (CRM) system and an enterprise resource planning (ERP) system, the method performed by one or more computing devices comprising instructions stored in a memory, which when executed by one or more processors of the one or more computing devices, cause the one or more computing devices to perform the method comprising:
receiving a command to initiate a CRM transaction, wherein the CRM transaction has a workflow that is to be executed by a CRM system;
based on the CRM transaction, determining a first microcomponent associated with the workflow of the CRM transaction, wherein the first microcomponent is an integration link to an ERP system, wherein the ERP system maintains information relevant to the CRM transaction;
using the first microcomponent, retrieving information from the ERP system, wherein the information is associated with the workflow for the CRM transaction;
providing in real-time the information retrieved from the ERP system by the first microcomponent to the CRM system for use in the workflow of the CRM transaction;
determining a second microcomponent associated with the workflow of the CRM transaction, wherein second microcomponent is another integration link to the ERP system;
using the second microcomponent, retrieving additional information from the ERP system, wherein the additional information is associated with the workflow for the CRM transaction; and
providing in real-time the additional information retrieved from the ERP system by the second microcomponent to the CRM system for use in the workflow of the CRM transaction.

2. The computer-based method of claim 1, wherein at least one of the first and second microcomponents are configurable.

3. The computer-based method of claim 2, wherein at least one of the first and second microcomponents are upgradable.

4. The computer-based method of claim 3, wherein the first microcomponent are configurable and upgradable without affecting the operation of the second microcomponent upgradable.

5. The computer-based method of claim 1, further comprising:
providing, by at least one of the first and second microcomponents, bi-directional data exchange between the CRM system and the ERP system.

6. The computer-based method of claim 5 wherein the bi-directional data exchange is in real time.

7. The computer-based method of claim 1, further comprising:
periodically executing a batch routine to synchronize data between the CRM system and the ERP system.

8. The computer-based method of claim 7, further comprising:
retrieving information from the ERP system using the first and second microcomponents in between the execution of successive batch routines.

9. The computer-based method of claim 8, wherein the batch routine is executed daily.

10. The computer-based method of claim 1, wherein the CRM transaction is a configure, price, quote (CPQ) process.

11. The computer-based method of claim 10, wherein the first microcomponent is a real time function to fetch sales organization data from the ERP system.

12. The computer-based method of claim 11, wherein the second microcomponent is a real time function to fetch plant availability data from the ERP system.

13. The computer-based method of claim 12, further comprising:
subsequent to receiving a request to configure a product associated with the CPQ process, retrieving rule-based configuration options from the EPR system using a configuration microcomponent.

14. A computing system comprising one or more non-transitory computer readable mediums having instructions stored thereon, which when executed by one or more processors cause the one or more processors to:
receive a command to initiate a customer relationship management (CRM) transaction, wherein the CRM transaction has a workflow that is to be executed by a CRM system;
based on the CRM transaction, determine a first microcomponent associated with the workflow of the CRM transaction, wherein the first microcomponent is an integration link to an enterprise resource planning (ERP) system, wherein the ERP system maintains information relevant to the CRM transaction;
using the first microcomponent, retrieve information from the ERP system, wherein the information is associated with the workflow for the CRM transaction;
provide in real-time the information retrieved from the ERP system by the first microcomponent to the CRM system for use in the workflow of the CRM transaction;
determine a second microcomponent associated with the workflow of the CRM transaction, wherein second microcomponent is another integration link to the ERP system;
using the second microcomponent, retrieve additional information from the ERP system, wherein the additional information is associated with the workflow for the CRM transaction; and
provide in real-time the additional information retrieved from the ERP system by the second microcomponent to the CRM system for use in the workflow of the CRM transaction.

15. The computing system of claim 14, wherein at least one of the first and second microcomponents are configurable.

16. The computing system of claim 15, wherein at least one of the first and second microcomponents are upgradable.

17. The computing system of claim 16, wherein the first microcomponent can be configured and upgraded without affecting the operation of the second microcomponent upgradable.

18. The computing system of claim 14, further comprising:
provide, by at least one of the first and second microcomponents, bi-directional data exchange between the CRM system and the ERP system.

19. The computing system of claim 18, wherein the bi-directional data exchange is in real time.

20. The computing system of claim 14, wherein the CRM transaction is a configure, price, quote (CPQ) process.

21. The computing system of claim 20, wherein the first microcomponent is a real time function to fetch sales organization data from the ERP system.

22. The computing system of claim 21, wherein the second microcomponent is a real time function to fetch plant availability data from the ERP system.

23. The computing system of claim 22, further comprising:
subsequent to receiving a request to configure a product associated with the CPQ process, retrieve rule-based configuration options from the EPR system using a configuration microcomponent.

24. A computer-based method of integrating a customer relationship management (CRM) system and an enterprise resource planning (ERP) system, the method performed by one or more computing devices comprising instructions stored in a memory, which when executed by one or more processors of the one or more computing devices, cause the one or more computing devices to perform the method comprising:
receiving a command to initiate a CRM transaction, wherein the CRM transaction is a configure, price, quote (CPQ) process having a workflow that is to be executed by a CRM system;
based on the CRM transaction, determining a sales organization picker microcomponent associated with the workflow of the CRM transaction, wherein sales organization picker microcomponent is an integration link to an ERP system, wherein the ERP system maintains information relevant to the CRM transaction;
using the sales organization picker microcomponent, retrieving information from the ERP system, wherein the information is associated with the workflow for the CRM transaction;
providing in real-time the information retrieved from the ERP system by the sales organization picker microcomponent to the CRM system for use in the workflow of the CRM transaction;
determining a plant picker microcomponent associated with the workflow of the CRM transaction, wherein plant picker microcomponent is another integration link to the ERP system;
using the plant picker microcomponent, retrieving additional information from the ERP system, wherein the additional information is associated with the workflow for the CRM transaction; and
providing in real-time the additional information retrieved from the ERP system by the plant picker microcomponent to the CRM system for use in the workflow of the CRM transaction.

25. A computing system comprising one or more non-transitory computer readable mediums having instructions stored thereon, which when executed by one or more processors cause the one or more processors to:
receive a command to initiate a configure, price, quote (CPQ) transaction, wherein the CPQ transaction has a workflow that is to be executed by a CPQ system;
based on the CPQ transaction, determine a first microcomponent associated with the workflow of the CPQ transaction, wherein the first microcomponent is an integration link to an enterprise resource planning (ERP) system, wherein the CPQ system maintains information relevant to the CPQ transaction;
using the first microcomponent, retrieve information from the ERP system, wherein the information is associated with the workflow for the CPQ transaction;
provide in real-time the information retrieved from the ERP system by the first microcomponent to the CPQ system for use in the workflow of the CPQ transaction;
determine a second microcomponent associated with the workflow of the CPQ transaction, wherein second microcomponent is another integration link to the ERP system;
using the second microcomponent, retrieve additional information from the ERP system, wherein the additional information is associated with the workflow for the CPQ transaction; and
provide in real-time the additional information retrieved from the ERP system by the second microcomponent to the CPQ system for use in the workflow of the CPQ transaction.

26. The computing system of claim 25, wherein at least one of the first and second microcomponents are configurable.

27. The computing system of claim 26, wherein at least one of the first and second microcomponents are upgradable.

28. The computing system of claim 27, wherein the first microcomponent can be configured and upgraded without affecting the operation of the second microcomponent upgradable.

29. The computing system of claim 25, further comprising:
provide, by at least one of the first and second microcomponents, bi-directional data exchange between the CPQ system and the ERP system.

30. The computing system of claim 29, wherein the bi-directional data exchange is in real time.
